(19) United States
(12) Patent Application Publication
(10) Pub. No.: US 2022/0203988 A1
(43) Pub. Date: Jun. 30, 2022

(54) METHOD FOR DRIVING A VEHICLE PLATOON

(71) Applicant: Ningbo Geely Automobile Research & Development Co., Ltd., Ningbo (CN)

(72) Inventors: Magnus BRANDIN, Mölnlycke (SE); Markus BÖLANDER, Göteborg (SE)

(21) Appl. No.: 17/697,441

(22) Filed: Mar. 17, 2022

Related U.S. Application Data
(63) Continuation of application No. PCT/CN2020/115758, filed on Sep. 17, 2020.

(30) Foreign Application Priority Data
Sep. 25, 2019 (EP) 19199474.8

(51) Int. Cl. B60W 30/182; G08G 1/00

(52) U.S. Cl. CPC B60W 30/182; G08G 1/22; B60W 2540/106; B60W 2710/18; B60W 2540/12; B60W 2720/106

(57) ABSTRACT

A method for driving a vehicle platoon having a lead vehicle and vehicles following the lead vehicle. The method includes providing first and second modes for driving the lead vehicle, by using a first brake map for the first mode and a second brake map for the second mode for braking the lead vehicle, the first brake map gives a lower brake force on the lead vehicle than the second brake map for equal brake requests; and/or by using a first acceleration map for the first mode and a second acceleration map for the second mode for accelerating the lead vehicle, wherein the first acceleration map gives a lower traction force on the lead vehicle than the second acceleration map for equal acceleration requests, and shifting from the first mode to the second mode when an operator of the lead vehicle has performed a predetermined driving action.

### RELATED APPLICATION DATA

This application is a continuation of International Patent Application No. PCT/CN2020/115758, filed Sep. 17, 2020, which claims the benefit of European Patent Application No. 19199474.8, filed Sep. 25, 2019, the disclosures of which are incorporated herein by reference in their entireties.

### TECHNICAL FIELD

The invention relates to a method for driving a vehicle platoon and a control unit for controlling a vehicle platoon.

### BACKGROUND

For the vehicles of a vehicle platoon, the lead vehicle decides on acceleration levels for the other following vehicles of the vehicle platoon. The time gap between vehicles in a vehicle platoon is often relatively short requiring a quick response of the control system. There is however always some time delay before the following vehicles will react and accelerate according to the acceleration of the lead vehicle. The driving style of an operator of the lead vehicle will have a direct impact on the control system response which in turn has an impact on the comfort to the passengers of the following vehicles and the energy used for driving the vehicle platoon.

### SUMMARY

An objective of the invention is to provide a method for driving a vehicle platoon, by which method a vehicle platoon can be driven with improved comfort in an energy efficient way.

The objective is achieved by a method for driving a vehicle platoon having a lead vehicle and a plurality of vehicles following the lead vehicle, where the method comprises the steps of providing a first mode and a second mode for driving the lead vehicle, by using a first brake map for the first mode and a second brake map for the second mode for braking the lead vehicle, where the first brake map gives a lower brake force on the lead vehicle than the second brake map for equal brake requests, and/or by using a first acceleration map for the first mode and a second acceleration map for the second mode for accelerating the lead vehicle, where the first acceleration map gives a lower traction force on the lead vehicle than the second acceleration map for equal acceleration requests, and the step of shifting from the first mode to the second mode when an operator of the lead vehicle has performed a predetermined driving action.

The invention is based on the insight that by such method, the vehicle platoon can be driven in a comfort mode where it can be compensated for the driving behaviour of the lead vehicle operator for achieving a smoother driving of the following vehicles. The first mode can be a default mode for improved comfort and reduced energy consumption. At the same time, the second mode can be a safety mode used only when a critical situation requires a higher or faster control system response.

The “brake map” and “acceleration map” that transform the input including a brake request or an acceleration request to a predetermined output including a brake force or traction force, may comprise one or more lookup tables for achieving the desired mapping.

According to one embodiment of the method, the method comprises the step of providing the first brake map for the first mode and the second brake map for the second mode for braking the lead vehicle, where the first brake map gives a lower brake force change speed than the second brake map for equal brake requests. Hereby, the driver of the lead vehicle is able to use the brakes smoothly and provide improved comfort to the vehicles of the vehicle platoon in the first mode, at the same time as a quicker response can be obtained by shifting from the first mode to the second mode if required.

According to a further embodiment, the method comprises the step of providing the first acceleration map for the first mode and the second acceleration map for the second mode for accelerating the lead vehicle, where the first accelerating map gives a lower traction force change speed than the second acceleration map for equal acceleration requests. Hereby, the driver of the lead vehicle is able to avoid jerky driving which would have a negative impact on the entire vehicle platoon. The comfort is improved and the energy consumption is reduced, at the same time as a quicker response can be obtained by shifting from the first mode to the second mode.

According to a further embodiment, the method comprises the step of shifting from the first mode to the second mode when a brake pedal position of the lead vehicle is changed with a speed exceeding a predetermined threshold value. The speed of the brake pedal can be detected and used for shifting brake modes, and a high speed of the brake pedal can be used as an indicator that a safety mode is required.

According to a further embodiment, the method comprises the step of shifting from the first mode to the second mode when a brake pedal speed change of the lead vehicle exceeds a predetermined threshold value. The speed change of the brake pedal can be detected and used for shifting brake modes, and a high speed change of the brake pedal can be used as an indicator that a safety mode is required.

According to a further embodiment, the method comprises the step of shifting from the first mode to the second mode when a brake pedal of the lead vehicle is moved a distance exceeding a predetermined threshold value. The position of the brake pedal can be detected and used for shifting brake modes, and if the brake pedal has been moved a large distance, this can be used as an indicator that a safety mode is required.

According to a further embodiment, the method comprises the step of shifting from the first mode to the second mode when an accelerator pedal position of the lead vehicle is changed with a speed exceeding a predetermined threshold value. The speed of the acceleration pedal can be detected and used for shifting acceleration modes, and a high speed of the acceleration pedal can be used as an indicator that a safety mode is required.

According to a further embodiment, the method comprises the step of shifting from the first mode to the second mode when an accelerator pedal speed change of the lead vehicle exceeds a predetermined threshold value. The speed change of the acceleration pedal can be detected and used for shifting acceleration modes, and a high speed change of the acceleration pedal can be used as an indicator that a safety mode is required.

According to a further embodiment, the method comprises the step of shifting from the first mode to the second mode when an accelerator pedal of the lead vehicle is moved a distance exceeding a predetermined threshold value. The position of the acceleration pedal can be detected and used for shifting acceleration modes, and if the acceleration pedal has been moved a large distance, this can be used as an indicator that a safety mode is required.

According to a further embodiment, the method comprises the step of communicating to one or more of the plurality of following vehicles that a shift from the first mode to the second mode for the lead vehicle has taken place. Hereby, it is possible to change brake and/or acceleration mode also for the following vehicles for achieving a higher or faster control system response adapted to the control of the lead vehicle.

According to another aspect of the invention, a further objective is to provide a control unit for controlling a vehicle platoon, by which control unit a vehicle platoon can be driven with improved comfort in an energy efficient way.

This objective is achieved by a control unit for controlling a vehicle platoon having a lead vehicle and a plurality of vehicles following the lead vehicle, where the control unit is configured to provide a first mode and a second mode for the lead vehicle, by using a first brake map for the first mode and a second brake map for the second mode for controlling a brake of the lead vehicle, where the first brake map gives a lower brake force on the lead vehicle than the second brake map for equal brake requests, and/or by using a first acceleration map for the first mode and a second acceleration map for the second mode for controlling a drive unit of the lead vehicle, where the first acceleration map gives a lower traction force on the lead vehicle than the second acceleration map for equal acceleration requests, and the control unit is configured to shift from the first mode to the second mode when receiving an input signal indicating that an operator of the lead vehicle has performed a predetermined driving action.

The advantages of the control unit are similar to the advantages already discussed hereinabove with reference to the different embodiments of the method.

Further advantages and advantageous features of the invention are disclosed in the following description and in the claims.

### BRIEF DESCRIPTION OF THE DRAWINGS

With reference to the appended drawings, below follows a more detailed description of embodiments of the invention cited as examples.

In the drawings:

FIG. 1 shows a vehicle platoon,

FIG. 2 shows two vehicle platoons driving in different lanes of a road,

FIG. 3 is a schematic view of a control unit for controlling a brake and a drive unit of a lead vehicle of a vehicle platoon,

FIG. 4 shows an example of a lookup table of a brake map,

FIG. 5 shows a further example of a lookup table for a brake map,

FIG. 6 shows shifting from a first mode to a second mode where the vehicle output is gradually increased, and

FIG. 7 shows shifting from a first mode to a second mode where the vehicle output is substantially instantaneously increased.

### DETAILED DESCRIPTION

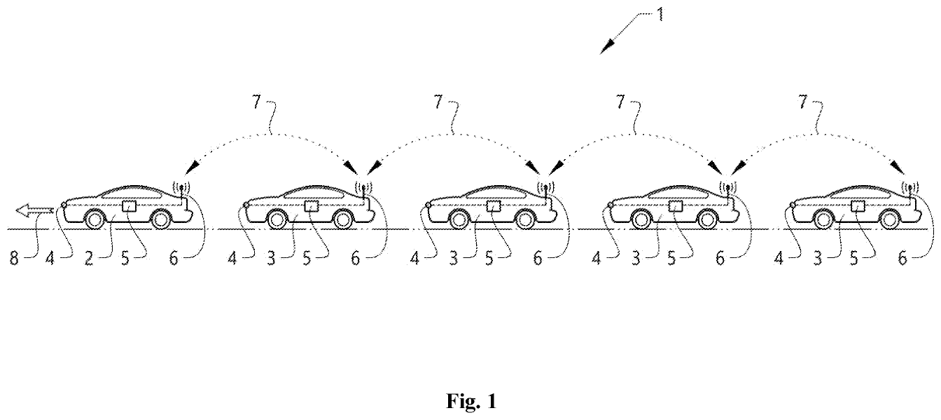

FIG. 1 shows a vehicle platoon 1 having a lead vehicle 2 and a plurality of following vehicles 3. The lead vehicle 2 and the following vehicles 3 are individual vehicles but driven together as a group or convoy. The following vehicles 3 are positioned in a line after the lead vehicle 2. The driving direction is indicated with an arrow 8. The lead vehicle 2 is at least partly controlled by an operator of the lead vehicle. The following vehicles 3 of the vehicle platoon are suitably automatically controlled without any driver assistance.

When driving in the vehicle platoon 1, the following vehicles 3 are controlled to follow the lead vehicle 2 or the vehicle closest to the front, such that when the speed of the lead vehicle 2 is increased/decreased the speed of the following vehicles 3 is increased/decreased correspondingly for maintaining or achieving the desired distances and time gaps between the vehicles. Further, when the lead vehicle 2 is changing driving direction, a following vehicle 3 will also change driving direction and follow the lead vehicle or rather the vehicle closest to the front.

For enabling the vehicles 2, 3 to be controlled, each vehicle can be provided with any suitable sensor equipment 4 for receiving information about the environment, and a control unit 5 for controlling the vehicle. The sensor equipment can give information about at least the vehicle closest to the front, but preferably the sensor equipment is covering 360 degrees around the vehicle for obtaining the information that is required for longitudinal and lateral control of the vehicle. Such sensor equipment 4 may comprise LIDAR, radar and ultrasonic sensors, cameras, etc. The information received by the sensor equipment is used by the control unit 5 for controlling the driving behaviour of the vehicle. In addition, maps, GPS, etc., can be used for determining the current position of a vehicle platoon or an individual vehicle of a vehicle platoon.

Alternatively or in addition to the sensor equipment 4, each vehicle 2, 3 is provided with a communication unit 6 for communicating with one or more of the other vehicles of the vehicle platoon 1. Such a communication unit 6 may comprise any suitable components for establish communication between the vehicles. For example, the communication unit 6 may comprise a transmitter and a receiver based on radio waves or microwaves. In other words, each vehicle can be part of a local network for communication 7 between the vehicles of the vehicle platoon 1. By means of the local network, control signals can be transmitted from one vehicle to another vehicle. The control signals received are then used by the control unit 5 arranged on the vehicle for controlling the driving behaviour of the vehicle. Such control signals received by the following vehicles 3 are preferably at least initially transmitted by the lead vehicle 2.

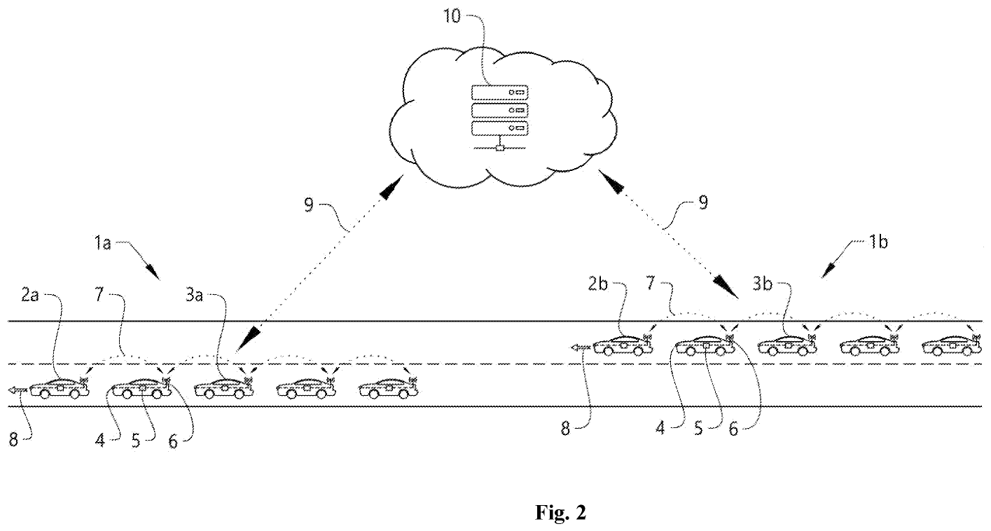

FIG. 2 shows two vehicle platoons 1a, 1b driving in different lanes of a road. Each vehicle platoon 1a, 1b of the current traffic system is also part of a central network for communication 9 between the vehicle platoon 1a, 1b and a central control unit 10. By means of the central network, control signals can be transmitted from the central control unit 10 to a vehicle platoon 1a, 1b for controlling the driving behaviour of the vehicle platoon. Such control signals are preferably received by the lead vehicle 2a, 2b of the vehicle platoon, but could also be received by one or more of the following vehicles 3 of the vehicle platoon. The central control unit 10 can be part of a server of a wireless network, such as Internet, for cloud computing.

The central control unit 10 and the local control unit 5 arranged on a vehicle may comprise one or more microprocessors and/or one or more memory devices or any other components for executing computer programs to perform the method described hereinafter.

Thus, the central control unit and/or the local control unit is preferably provided with a computer program comprising program code means for performing the steps of any example embodiment of the method described hereinafter.

For controlling a vehicle platoon or an individual vehicle of the vehicle platoon, preferably both the control unit 5 of the vehicle and the central control unit 10 are used in cooperation.

Alternatively or in addition to what has been described hereinabove, sensors can be arranged in the environment to the current road where the vehicle platoon is driven. These sensors may provide information to be received by the control unit 5 and/or the central control unit 10. Such sensors could be a complement to the sensors of the vehicles, giving further information and/or redundancy to the system.

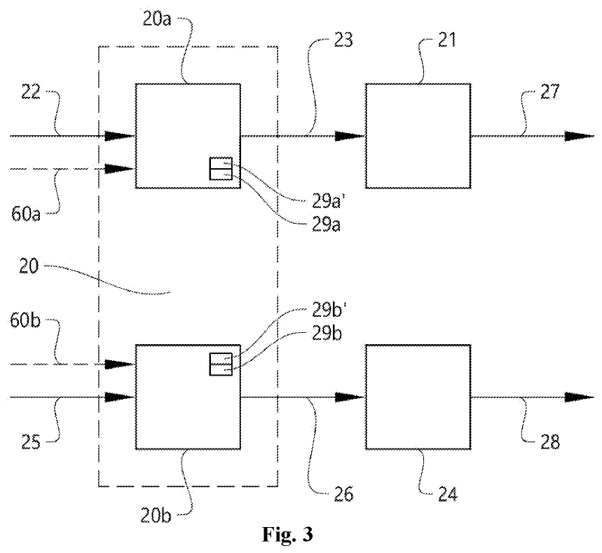

The upper part of FIG. 3 is a schematic view of a control unit 20a for controlling a brake 21 of a lead vehicle of a vehicle platoon. A brake request signal 22 is input to the control unit 20a comprising brake maps 29a, 29a′. A brake force signal 23 is output from the control unit 20 and input to the brake 21. The brake force signal 23 is used for controlling braking of the vehicle. The brake 21 can be any suitable equipment such as a disc brake, a part of a drive line, engine braking, etc., for generating a brake force braking the vehicle. The brake request signal 22 is generated by an action of the operator of the lead vehicle, for example by means of pushing a brake pedal. The brake request signal 22 can be a function of the brake pedal position.

The lower part of FIG. 3 is a schematic view of a control unit 20b for controlling a drive line 24 of a lead vehicle of a vehicle platoon. An acceleration request signal 25 is input to the control unit 20b comprising acceleration maps 29b, 29b′. A traction force signal 26 is output from the control unit 20b. The traction force signal 26 is used for controlling acceleration of the vehicle. The drive line 24 can comprise any suitable equipment such as an engine, an electric motor, etc., for generating a traction force accelerating the vehicle. The acceleration request signal 25 is generated by an action of the operator of the lead vehicle, for example by means of pushing an acceleration pedal. The acceleration request signal 25 can be a function of the acceleration pedal position.

Although separate chart flows have been used in FIG. 3 for illustrating the brake force control and the traction force control, the control unit 20a for controlling the brake and the control unit 20b for controlling the drive line could be one and the same control unit or at least be integrated in the same unit. For simplifying, reference is made to the control unit 20 hereinafter when referring to the control unit 20a for controlling the brake and/or the control unit 20b for controlling the drive line.

Further, this control unit 20 can be included in the control unit 5 arranged on the vehicle.

The control unit 20 is configured to provide a first mode and a second mode for the lead vehicle. The first mode and the second mode are achieved by using a first brake map 29a for the first mode and a second brake map 29a′ for the second mode for controlling the brake 21 of the lead vehicle. The first brake map 29a gives a lower brake force 27 on the lead vehicle 2 than the second brake map 29a′ for equal brake requests 22. Alternatively or in addition to the first brake map and the second brake map, the first mode and the second mode are achieved by using a first acceleration map 29b for the first mode and a second acceleration map 29b′ for the second mode for controlling the drive unit 24 of the lead vehicle. The first acceleration map 29b gives a lower traction force 28 on the lead vehicle 2 than the second acceleration map 29b′ for equal acceleration requests 25.

The lower brake force output and the lower traction force output for the first mode in comparison to the second mode is applied for at least a significant part of the brake request interval and the acceleration request interval, respectively.

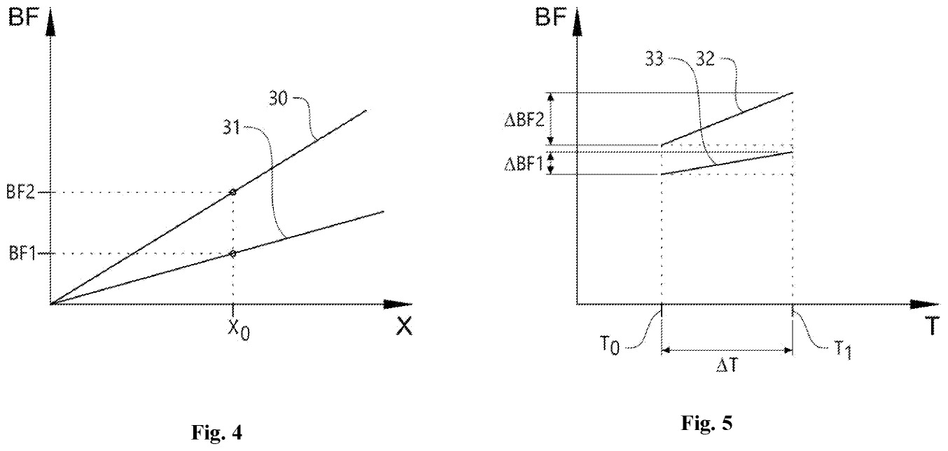

FIG. 4 shows an example of a lookup table of a brake map. In the graph, the horizontal axis represents the position X of the brake pedal and the vertical axis represents the brake force BF. The upper line 30 shows brake force as a function of brake pedal position for the second mode, and the line 31 below shows brake force as a function of brake pedal position for the first mode. As appears in the graph, for the same brake pedal position x₀, the brake force BF2 for the second mode is larger than the brake force BF1 for the first mode.

When the control unit 20 is configured to provide the first brake map 29a for the first mode and the second brake map 29a′ for the second mode for controlling the brake 21, the first brake map can give a lower brake force change speed than the second brake map for equal brake requests 22. In other words, when increased braking of the lead vehicle 2 is requested, the response is slower in the first mode than in the second mode.

FIG. 5 shows an example of a lookup table for a brake map. In the graph, the horizontal axis represents time T and the vertical axis represents the brake force BF. The upper line 32 shows brake force as a function of time for the second mode, and the line 33 below shows brake force as a function of time for the first mode. The graph illustrates that at a time point T₀, the brake pedal has been moved a certain distance Δx. Then, the brake force is increased during ΔT from T₀ to T₁. As appears from the graph, for the same time period ΔT, the change in brake force ΔBF2 for the second mode is larger than the change in brake force ΔBF1 for the first mode. Thus, the brake force change speed is higher in the second mode than in the first mode.

Correspondingly, when the control unit 20 is configured to provide the first acceleration map 29b for the first mode and the second acceleration map 29b′ for the second mode for controlling the drive unit 24, the first accelerating map can give a lower traction force change speed than the second acceleration map for equal acceleration requests. In other words, when increased acceleration of the lead vehicle 2 is requested, the response is slower in the first mode than in the second mode.

The first mode can be a comfort mode providing smoother driving and reduced energy consumption. The first mode can be selected by the operator of the lead vehicle or automatically activated as a default mode.

The control unit 20 is further configured to shift from the first mode to the second mode when receiving an input signal 60a, 60b indicating that an operator of the lead vehicle 2 has performed a predetermined driving action. See FIG. 3. The input signal 60a, 60b can be the same signal or part of the brake request signal 22 or the acceleration request signal 25, or be a separate signal. The second mode can be a safety mode in which the maneuverability of the vehicle is prioritized over comfort and energy consumption. The predetermined driving action is suitably such an action which the operator is supposed to perform in case of a critical situation where maximal deceleration or acceleration is desired.

For example, such driving actions can be one or more of the following cases: a brake pedal position of the lead vehicle is changed with a speed exceeding a predetermined threshold value, a brake pedal speed change of the lead vehicle exceeds a predetermined threshold value, and a brake pedal of the lead vehicle is moved a distance exceeding a predetermined threshold value. Furthermore, such driving actions can be one or more of the following cases: an acceleration pedal position of the lead vehicle is changed with a speed exceeding a predetermined threshold value, an acceleration pedal speed change of the lead vehicle exceeds a predetermined threshold value, and an acceleration pedal of the lead vehicle is moved a distance exceeding a predetermined threshold value.

In addition to the possibility for an operator of the lead vehicle to shift modes by performing a predetermined driving action, in case of an identified increased risk level (which may not have been perceived by the operator) for the lead vehicle or the entire vehicle platoon, shifting from the first mode to the second mode can also be performed automatically by a control unit 5 arranged on the vehicle or a central control unit 10 without any action from the operator. The increased risk level can be detected by any sensor equipment of a vehicle of the vehicle platoon or identified by any external system providing information about the current traffic situation.

Also when describing the method herein, reference to FIGS. 1-7 is made.

The method comprises the steps of providing a first mode and a second mode for driving the lead vehicle, by using a first brake map 29a for the first mode and a second brake map 29a′ for the second mode for braking the lead vehicle 2. The first brake map 29a gives a lower brake force on the lead vehicle than the second brake map 29a′ for equal brake requests 22. Alternatively or in addition to the first brake map and the second brake map, the first mode and the second mode is achieved by using a first acceleration map 29b for the first mode and a second acceleration map 29b′ for the second mode for accelerating the lead vehicle 2. The first acceleration map 29b gives a lower traction force on the lead vehicle than the second acceleration map 29b′ for equal acceleration requests 25. The method also comprises the step of shifting from the first mode to the second mode when an operator of the lead vehicle 2 has performed a predetermined driving action.

The method can comprise the step of communicating to one or more of the plurality of following vehicles 3 that a shift from the first mode to the second mode for the lead vehicle 2 has taken place. This information can be used by a control unit 5 of a following vehicle for adapting the control system response of the following vehicle to the current mode of the lead vehicle. For following the lead vehicle when driven in the second mode, a higher or faster control system response of the following vehicle is suitably used.

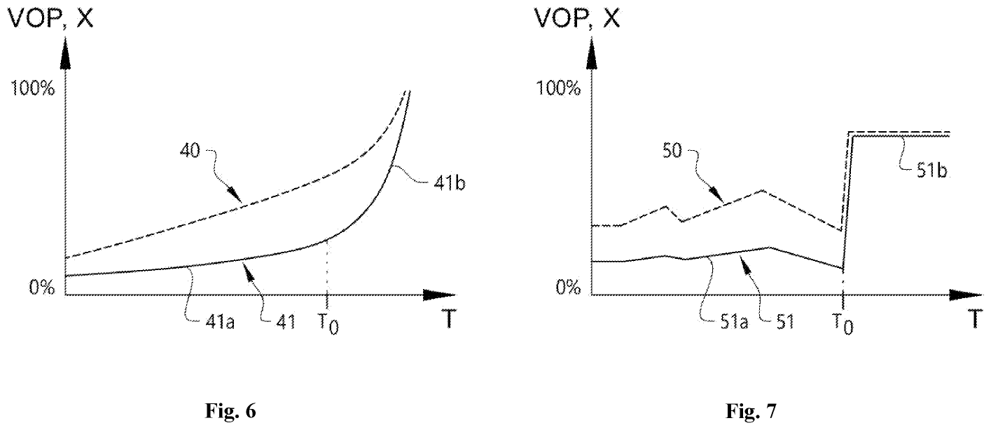

FIGS. 6 and 7 show two examples of graphs illustrating vehicle output and pedal position when shifting from the first mode to the second mode. The vehicle output can be brake force or traction force (acceleration) and the pedal can be a brake pedal or an acceleration pedal.

In FIG. 6, the graph shows vehicle output VOP and pedal position X versus time T.

A first curve 40 which is illustrated by a dotted line, shows the pedal position as a function of the time. A second curve 41 which is illustrated by a solid line, shows the vehicle output as a function of time. Before a time point T₀, the first mode is used and the vehicle output VOP varies with the time (and the pedal position) as indicated by the curve portion 41a provided in the first mode. At T₀ there is a shift from the first mode to the second mode.

After the time point T₀, the second mode is used and the vehicle output VOP varies with the time (and the pedal position) as indicated by the curve portion 41b provided in the second mode. The vehicle output is gradually increased when shifting from the first mode to the second mode. The shifting from the first mode to the second mode can be induced in any way as previously described hereinabove.

In FIG. 7, the graph shows vehicle output VOP and pedal position X versus time T. A first curve 50 which is illustrated by a dotted line, shows the pedal position as a function of the time. A second curve 51 which is illustrated by a solid line, shows the vehicle output as a function of time. Before a time point T₀, the first mode is used and the vehicle output VOP varies with the time (and the pedal position) as indicated by the curve portion 51a provided in the first mode. At T₀ there is a shift from the first mode to the second mode. After the time point T₀, the second mode is used and the vehicle output VOP varies with the time (and the pedal position) as indicated by the curve portion 51b provided in the second mode. The vehicle output is substantially instantaneously increased when shifting from the first mode to the second mode. The shifting from the first mode to the second mode can be induced in any way as previously described hereinabove.

It should be stressed that all example embodiments and features disclosed when describing how the control unit is configured, can be applied in the method, and for all example embodiments and features disclosed when describing the method, the control unit can be configured accordingly.

It is to be understood that the present invention is not limited to the embodiments described above and illustrated in the drawings; rather, the skilled person will recognize that many changes and modifications may be made within the scope of the appended claims.

What is claimed is:

1. A method for driving a vehicle platoon having a lead vehicle and a plurality of vehicles following the lead vehicle, the method comprising the steps of providing a first mode and a second mode for driving the lead vehicle, by using a first brake map for the first mode and a second brake map for the second mode for braking the lead vehicle, the first brake map giving a lower brake force on the lead vehicle than the second brake map for equal brake requests, and/or by using a first acceleration map for the first mode and a second acceleration map for the second mode for accelerating the lead vehicle, the first acceleration map giving a lower traction force on the lead vehicle than the second acceleration map for equal acceleration requests, and shifting from the first mode to the second mode when an operator of the lead vehicle has performed a predetermined driving action.

2. The method according to claim 1, wherein providing the first brake map for the first mode and the second brake map for the second mode for braking the lead vehicle, the first brake map giving a lower brake force change speed than the second brake map for equal brake requests.

3. The method according to claim 1, wherein providing the first acceleration map for the first mode and the second acceleration map for the second mode for accelerating the lead vehicle, the first accelerating map giving a lower traction force change speed than the second acceleration map for equal acceleration requests.

4. The method according to claim 1, wherein shifting from the first mode to the second mode when a brake pedal position of the lead vehicle is changed with a speed exceeding a predetermined threshold value.

5. The method according to claim 1, wherein shifting from the first mode to the second mode when a brake pedal speed change of the lead vehicle exceeds a predetermined threshold value.

6. The method according to claim 1, wherein shifting from the first mode to the second mode when a brake pedal of the lead vehicle is moved a distance exceeding a predetermined threshold value.

7. The method according to claim 1, wherein shifting from the first mode to the second mode when an accelerator pedal position of the lead vehicle is changed with a speed exceeding a predetermined threshold value.

8. The method according to claim 1, wherein shifting from the first mode to the second mode when an accelerator pedal speed change of the lead vehicle exceeds a predetermined threshold value.

9. The method according to claim 1, wherein shifting from the first mode to the second mode when an accelerator pedal of the lead vehicle is moved a distance exceeding a predetermined threshold value.

10. The method according to claim 1, wherein communicating to one or more of the plurality of following vehicles that a shift from the first mode to the second mode for the lead vehicle has taken place.

11. The method according to claim 1, wherein shifting from the first mode to the second mode for the lead vehicle when an increased risk level for a vehicle of the vehicle platoon or the entire vehicle platoon is identified.

12. A control unit for controlling a vehicle platoon having a lead vehicle and a plurality of vehicles following the lead vehicle, the control unit is configured to provide a first mode and a second mode for the lead vehicle, by using a first brake map for the first mode and a second brake map for the second mode for controlling a brake of the lead vehicle, the first brake map giving a lower brake force on the lead vehicle than the second brake map for equal brake requests, and/or by using a first acceleration map for the first mode and a second acceleration map for the second mode for controlling a drive unit of the lead vehicle, the first acceleration map giving a lower traction force on the lead vehicle than the second acceleration map for equal acceleration requests, and the control unit is configured to shift from the first mode to the second mode when receiving an input signal indicating that an operator of the lead vehicle has performed a predetermined driving action.

13. A non-transitory computer readable medium storing a computer program comprising program code for performing the method according to claim 1.

14. A lead vehicle for a vehicle platoon, the lead vehicle comprising a control unit according to claim 12.

15. A vehicle platoon comprising a lead vehicle and a plurality of following vehicles, the lead vehicle comprising a control unit according to claim 12.
